(19) United States
(12) Patent Application Publication
(10) Pub. No.: US 2024/0426047 A1
(43) Pub. Date: Dec. 26, 2024

(54) FABRIC TREATMENT

(71) Applicant: The Procter & Gamble Company, Cincinnati, OH (US)

(72) Inventors: Neil Joseph LANT, Newcastle upon Tyne (GB); Katherine Esther LATIMER, Newcastle upon Tyne (GB); Samuel Kimani NJOROGE, Montgomery, OH (US); Todd Michael WERNICKE, Cincinnati, OH (US)

(21) Appl. No.: 18/739,491

(22) Filed: Jun. 11, 2024

(30) Foreign Application Priority Data
Jun. 21, 2023 (EP) 23180607.6

(51) Int. Cl. D06M 16/00; D06L 1/16; D06M 13/272

(52) U.S. Cl. CPC D06M 16/003; D06L 1/16; D06M 13/272

(57) ABSTRACT

A method of treating a fabric, the method comprising the step of:
subjecting the fabric to a wash liquor comprising from 100 ppm to 600 ppm of a surfactant system; and
rising the fabric with a rinse liquor comprising from about 1×10² to about 1×10⁸ CFU/l of the aqueous liquor, of bacterial spores.

### FIELD OF THE INVENTION

The present invention relates to a method of treating a fabric to provide cleaning of the fabric, malodor reduction and malodor prevention.

### BACKGROUND OF THE INVENTION

In cleaning applications, particularly for laundry, stain and malodor removal is a continuing problem. There are many cleaning technologies aimed at mitigating such problem however, it is a constant challenge to provide improved efficacy and especially in an environmentally favorable manner. In automatic washing machines these problems are compounded by the increased use of low wash temperatures (e.g., cold water) and shorter washing cycles which reduce stain/soil and malodor removal efficacy of detergent compositions.

Thus, it is an object of the present invention to provide a detergent composition, particularly for laundry which can be used in a washing process, even at low temperatures and short wash times, which will provide improved cleaning and at the same time malodor reduction and malodor prevention.

### SUMMARY OF THE INVENTION

According to the first aspect of the invention, there is provided a method of treating a fabric, the method comprising the step of:
i. subjecting the fabric to a wash liquor comprising from 100 ppm to 600 ppm of a surfactant system; and
ii. rinsing the fabric with a rinse liquor comprising from about 1×10² to about 1×10⁸ CFU/l of the aqueous liquor, of bacterial spores, preferably Bacillus spores.

The method provides good cleaning, even with a low level of surfactant and at low temperature and short cycles. The method also provides malodor removal and malodor prevention.

According to the second aspect of the invention, there is provided the use of the method to improve spore deposition on fabrics during a laundry process.

The elements of the method of the invention described in relation to the first aspect of the invention apply mutatis mutandis to the second aspect of the invention.

### DETAILED DESCRIPTION OF THE INVENTION

The present invention encompasses a method of treating a fabric, the method providing good cleaning and at the same time improved bacterial spores deposition on the fabric.

The present invention also encompasses the use of the method of the invention to provide improved bacterial spore deposition on fabrics. The method may provide sustained malodor removal and malodor prevention from the fabric. By “sustained malodor removal” is meant that the malodor removal and/or prevention takes place for at least 24 hours, preferably for at least 48 hours after the fabric has been treated. Without being bound by theory it is believed that the bacterial spores germinate and grow in response to heat, moisture, and nutrients provided by common laundry soils. This metabolism of soils and odors is believed to cause malodor removal and prevention during the wearing of the fabric.

As used herein, the articles “a” and “an” when used in a claim, are understood to mean one or more of what is claimed or described. As used herein, the terms “include,” “includes,” and “including” are meant to be non-limiting. The compositions of the present disclosure can comprise, consist essentially of, or consist of, the components of the present disclosure.

All percentages, ratios and proportions used herein are by weight percent of the composition, unless otherwise specified. All average values are calculated “by weight” of the composition, unless otherwise expressly indicated. All ratios are calculated as a weight/weight level, unless otherwise specified.

All measurements are performed at 25° C. unless otherwise specified.

Unless otherwise noted, all component or composition levels are in reference to the active portion of that component or composition, and are exclusive of impurities, for example, residual solvents or by-products, which may be present in commercially available sources of such components or compositions.

By “substantially free aqueous liquor” is meant that the aqueous liquor comprises less than 10 ppm of the specific compound.

By “substantially free composition” is meant that a composition comprises less than 1%, preferably less than 0.5% and especially 0 of the specific compound.

### Method of Treating a Fabric

The present disclosure relates to a method of treating a fabric to provide cleaning and deposit bacterial spores on the fabric, preferably the bacterial spores comprise Bacillus spores.

The method of the present disclosure includes contacting the fabric with a wash liquor comprising from 100 ppm to 600 ppm of a surfactant system, preferably from 200 ppm to 500 ppm and specially from 250 ppm to 450 ppm. The method also comprises rinsing the fabric with a rinsing liquor. The liquor is preferably aqueous and comprises at least 1×10² CFU/l of the rinse liquor, preferably from about 1×10² to about 1×10⁸ CFU/l of the rinse liquor of bacterial spores, preferably Bacillus spores.

The method of treating a fabric may take place in any suitable vessel, in its entirety or partially, for example it may take place in an automatic washing machine. Such machines may be top-loading machines or front-loading machines. The whole process can take place in a washing machine. The process of the invention is also suitable for hand washing applications.

The method of the present disclosure includes firstly contacting the fabric with wash liquor, preferably aqueous liquor followed by rinsing the fabric with a rinse liquor, preferably an aqueous liquor. The aqueous wash liquor may comprise a cleaning composition, such as a granular or liquid laundry detergent composition, that is dissolved or diluted in water. The composition comprises a surfactant system. The aqueous wash liquor comprises from about 100 to about 600 ppm, or from about 100 to about 500 ppm of surfactant system.

The bacterial spores are delivered in the rinse cycle.

### Fabric

The fabric treated by the method of the invention can be any fabric, including synthetic fabrics and fabrics made of fibers of natural origin (e.g. cotton, flax, jute, hemp, ramie, silk, wool, mohair, cashmere) or regenerated from a cellulosic feedstock (e.g. viscose/Lyocell/rayon and related regenerated celluloses, acetate, triacetate). Examples of suitable synthetic fibers include polyester, acrylic, elastane (Spandex, Lycra), polyamide (Nylon), polyethylene, polypropylene, polyurethane. The fiber composition of a textile is typically declared by the manufacturer, but it can also be determined experimentally using test methods familiar to those skilled in the art, such as ASTM D629-15: Standard Test Methods for Quantitative Analysis of Textiles, ASTM International, West Conshohocken, PA; 2015.

By “synthetic fabric” is herein meant a fabric that comprises more than 70% by weight of the fabric of synthetic fiber, preferably more than 80%, preferably more than 95%, preferably more than 98%, preferably about 100% by weight of the fabric of synthetic fiber.

### Composition

The present disclosure relates to a method for treating a fabric. As used herein the phrase “fabric treatment compositions” includes compositions designed for treating fabric, including garments, or other textiles.

The surfactant system used in the method of the invention is preferably part of a laundry cleaning composition. The surfactant system can be dosed as a fully formulated detergent or it can be dosed from a reservoir of a detergent auto-dosing system, as for example, the auto-dosing system described in WO 2019/063402 A1.

The rinse liquor of the method of the invention can be substantially free of fabric conditioning actives. Fabric conditioning actives include quaternary ammonium ester compounds, silicones, non-ester quaternary ammonium compounds, amines, fatty esters, sucrose esters, silicones, dispersible polyolefins, polysaccharides, fatty acids, softening or conditioning oils, polymer latexes, or combinations thereof. The wash liquor is preferably free of bleach.

The composition comprising the surfactant system may be in any suitable form. It may be in the form of a liquid composition, a granular composition, a single-compartment pouch, a multi-compartment pouch, a sheet, a pastille or bead, a fibrous article, a tablet, a bar, flake, or a mixture thereof. The product can be selected from a liquid, solid, or combination thereof.

The composition may be in liquid form. The composition may include from about 30% to about 90%, or from about 50% to about 80%, by weight of the composition, of water. The pH of the composition is from about 1 to about 6 as measured at 20° C. If the composition is in liquid form the pH is measured neat, if the composition is in solid form the pH is measure in a 1% w/v aqueous solution.

The composition may be a cleaning or additive composition, it may be in the form of a unitized dose article, such as a tablet, a pouch, a sheet, or a fibrous article. Such pouches typically include a water-soluble film, such as a polyvinyl alcohol water-soluble film, that at least partially encapsulates a composition. Suitable films are available from MonoSol, LLC (Indiana, USA). The composition can be encapsulated in a single or multi-compartment pouch. A multi-compartment pouch may have at least two, at least three, or at least four compartments. A multi-compartmented pouch may include compartments that are side-by-side and/or superposed. The composition contained in the pouch or compartments thereof may be liquid, solid (such as powders), or combinations thereof. Pouched compositions may have relatively low amounts of water, for example less than about 20%, or less than about 15%, or less than about 12%, or less than about 10%, or less than about 8%, by weight of the detergent composition, of water.

The composition may be in the form of a pastille or bead. The pastille may include polyethylene glycol as a carrier. The polyethylene glycol may have a weight average molecular weight of from about 2000 to about 20,000 Daltons, preferably from about 5000 to about 15,000 Daltons, more preferably from about 6000 to about 12,000 Daltons.

The composition may comprise a non-aqueous solvent, which may act as a carrier and/or facilitate stability. Non-aqueous solvents may include organic solvents, such as methanol, ethanol, propanol, isopropanol, 1,3-propanediol, 1,2-propanediol, ethylene glycol, glycerine, glycol ethers, hydrocarbons, or mixtures thereof.

### Bacterial Spores

Although bacterial spores can be present on surfaces, the method of the invention involves the intentional addition of bacterial spores to the fabric surface in an amount capable of providing a consumer noticeable benefit, in particular malodor removal and prevention benefit. Preferably, the method of the invention requires the intentional addition of at least 1×10² CFU/l of rinse liquor, preferably at least 1×10³ CFU/l of rinse liquor, preferably at least 1×10⁴ CFU/l of rinse liquor, preferably at least 1×10⁵ CFU/l of rinse liquor and preferably less than 1×10¹² CFU/l of rinse liquor. By “intentional addition of bacterial spores” is herein meant that the spores are added in addition to the microorganisms that might be present on the surface.

The microbial spores used in the method and composition of the invention are added to a rinse cycle. The spores are not deactivated by heat at the temperatures found in a washing machine. The spores are fabric-substantive and provide malodor control during and after the laundry process, in particular during and after the use (e.g. wearing) of the fabrics.

The microbial spores of the method and composition of the invention can germinate on fabrics. The spores can be activated by heat, for example, heat generated during use of the fabric or by the heat provided in the washing machine. The spores can germinate when the fabrics are stored and/or used. Malodor precursors can be used by the bacteria produced by the spores as nutrients promoting germination.

The bacterial spores for use herein: i) are capable of surviving the temperatures found in a laundry process; ii) are fabric substantive; iii) have the ability to control odor; and iv) preferably have the ability to support the cleaning action of laundry detergents. The spores have the ability to germinate and to form cells during the treatment and continue to germinate and form cells on the fabrics using malodor precursors as nutrients. The spores can be delivered in liquid or solid form. Preferably, the spores are in solid form.

Some gram-positive bacteria have a two-stage lifecycle in which growing bacteria under certain conditions such as in response to nutritional deprivation can undergo an elaborate developmental program leading to spores or endospores formation. The bacterial spores are protected by a coat consisting of about 60 different proteins assembled as a biochemically complex structure with intriguing morphological and mechanical properties. The protein coat is considered a static structure that provides rigidity and mainly acting as a sieve to exclude exogenous large toxic molecules, such as lytic enzymes. Spores play critical roles in long term survival of the species because they are highly resistant to extreme environmental conditions. Spores are also capable of remaining metabolically dormant for years. Methods for obtaining bacterial spores from vegetative cells are well known in the field. In some examples, vegetative bacterial cells are grown in liquid medium. Beginning in the late logarithmic growth phase or early stationary growth phase, the bacteria may begin to sporulate. When the bacteria have finished sporulating, the spores may be obtained from the medium, by using centrifugation for example. Various methods may be used to kill or remove any remaining vegetative cells. Various methods may be used to purify the spores from cellular debris and/or other materials or substances. Bacterial spores may be differentiated from vegetative cells using a variety of techniques, like phase-contrast microscopy, automated scanning microscopy, high resolution atomic force microscopy or tolerance to heat, for example. Because bacterial spores are generally environmentally-tolerant structures that are metabolically inert or dormant, they are readily chosen to be used in commercial microbial products. Despite their ruggedness and extreme longevity, spores can rapidly respond to the presence of small specific molecules known as germinants that signal favorable conditions for breaking dormancy through germination, an initial step in the process of completing the lifecycle by returning to vegetative bacteria. For example, the commercial microbial products may be designed to be dispersed into an environment where the spores encounter the germinants present in the environment to germinate into vegetative cells and perform an intended function. A variety of different bacteria may form spores. Bacteria from any of these groups may be used in the compositions, methods, and kits disclosed herein. For example, some bacteria of the following genera may form spores: Acetonema, Alkalibacillus, Ammoniphilus, Amphibacillus, Anaerobacter, Anaerospora, Aneurinibacillus, Anoxybacillus, Bacillus, Brevibacillus, Caldanaerobacter, Caloramator, Caminicella, Cerasibacillus, Clostridium, Clostridiisalibacter, Cohnella, Dendrosporobacter, Desulfotomaculum, Desulfosporomusa, Desulfosporosinus, Desulfovirgula, Desulfunispora, Desulfurispora, Filifactor, Filobacillus, Gelria, Geobacillus, Geosporobacter, Gracilibacillus, Halonatronum, Heliobacterium, Heliophilum, Laceyella, Lentibacillus, Lysinibacillus, Mahella, Metabacterium, Moorella, Natroniella, Oceanobacillus, Orenia, Ornithinibacillus, Oxalophagus, Oxobacter, Paenibacillus, Paraliobacillus, Pelospora, Pelotomaculum, Piscibacillus, Planifilum, Pontibacillus, Propionispora, Salinibacillus, Salsuginibacillus, Seinonella, Shimazuella, Sporacetigenium, Sporoanaerobacter, Sporobacter, Sporobacterium, Sporohalobacter, Sporolactobacillus, Sporomusa, Sporosarcina, Sporotalea, Sporotomaculum, Syntrophomonas, Syntrophospora, Tenuibacillus, Tepidibacter, Terribacillus, Thalassobacillus, Thermoacetogenium, Thermoactinomyces, Thermoalkalibacillus, Thermoanaerobacter, Thermoanaeromonas, Thermobacillus, Thermoflavimicrobium, Thermovenabulum, Tuberibacillus, Virgibacillus, and/or Vulcanobacillus.

Preferably, the bacteria that may form spores are from the family Bacillaceae, such as species of the genera Aeribacillus, Aliibacillus, Alkalibacillus, Alkalicoccus, Alkalihalobacillus, Alkalilactibacillus, Allobacillus, Alteribacillus, Alteribacter, Amphibacillus, Anaerobacillus, Anoxybacillus, Aquibacillus, Aquisalibacillus, Aureibacillus, Bacillus, Caldalkalibacillus, Caldibacillus, Calditerricola, Calidifontibacillus, Camelliibacillus, Cerasibacillus, Compostibacillus, Cytobacillus, Desertibacillus, Domibacillus, Ectobacillus, Evansella, Falsibacillus, Ferdinandcohnia, Fermentibacillus, Fictibacillus, Filobacillus, Geobacillus, Geomicrobium, Gottfriedia, Gracilibacillus, Halalkalibacillus, Halobacillus, Halolactibacillus, Heyndrickxia, Hydrogenibacillus, Lederbergia, Lentibacillus, Litchfieldia, Lottiidibacillus, Margalitia, Marinococcus, Melghiribacillus, Mesobacillus, Metabacillus, Microaerobacter, Natribacillus, Natronobacillus, Neobacillus, Niallia, Oceanobacillus, Ornithinibacillus, Parageobacillus, Paraliobacillus, Paralkalibacillus, Paucisalibacillus, Pelagirhabdus, Peribacillus, Piscibacillus, Polygonibacillus, Pontibacillus, Pradoshia, Priestia, Pseudogracilibacillus, Pueribacillus, Radiobacillus, Robertmurraya, Rossellomorea, Saccharococcus, Salibacterium, Salimicrobium, Salinibacillus, Salipaludibacillus, Salirhabdus, Salisediminibacterium, Saliterribacillus, Salsuginibacillus, Sediminibacillus, Siminovitchia, Sinibacillus, Sinobaca, Streptohalobacillus, Sutcliffiella, Swionibacillus, Tenuibacillus, Tepidibacillus, Terribacillus, Terrilactibacillus, Texcoconibacillus, Thalassobacillus, Thalassorhabdus, Thermolongibacillus, Virgibacillus, Viridibacillu, Vulcanibacillus, Weizmannia. In various examples, the bacteria may be strains of Bacillus Bacillus acidicola, Bacillus aeolius, Bacillus aerius, Bacillus aerophilus, Bacillus albus, Bacillus altitudinis, Bacillus alveayuensis, Bacillus amyloliquefaciensex, Bacillus anthracis, Bacillus aquiflavi, Bacillus atrophaeus, Bacillus australimaris, Bacillus badius, Bacillus benzoevorans, Bacillus cabrialesii, Bacillus canaveralius, Bacillus capparidis, Bacillus carboniphilus, Bacillus cereus, Bacillus chungangensis, Bacillus coahuilensis, Bacillus cytotoxicus, Bacillus decisifrondis, Bacillus ectoiniformans, Bacillus enclensis, Bacillus fengqiuensis, Bacillus fungorum, Bacillus glycinifermentans, Bacillus gobiensis, Bacillus halotolerans, Bacillus haynesii, Bacillus horti, Bacillus inaquosorum, Bacillus infantis, Bacillus infernus, Bacillus isabeliae, Bacillus kexueae, Bacillus licheniformis, Bacillus luti, Bacillus manusensis, Bacillus marinisedimentorum, Bacillus mesophilus, Bacillus methanolicus, Bacillus mobilis, Bacillus mojavensis, Bacillus mycoides, Bacillus nakamurai, Bacillus ndiopicus, Bacillus nitratireducens, Bacillus oleivorans, Bacillus pacificus, Bacillus pakistanensis, Bacillus paralicheniformis, Bacillus paramycoides, Bacillus paranthracis, Bacillus pervagus, Bacillus piscicola, Bacillus proteolyticus, Bacillus pseudomycoides, Bacillus pumilus, Bacillus safensis, Bacillus salacetis, Bacillus salinus, Bacillus salitolerans, Bacillus seohaeanensis, Bacillus shivajii, Bacillus siamensis, Bacillus smithii, Bacillus solimangrovi, Bacillus songklensis, Bacillus sonorensis, Bacillus spizizenii, Bacillus spongiae, Bacillus stercoris, Bacillus stratosphericus, Bacillus subtilis, Bacillus swezeyi, Bacillus taeanensis, Bacillus tamaricis, Bacillus tequilensis, Bacillus thermocloacae, Bacillus thermotolerans, Bacillus thuringiensis, Bacillus tianshenii, Bacillus toyonensis, Bacillus tropicus, Bacillus vallismortis, Bacillus velezensis, Bacillus wiedmannii, Bacillus wudalianchiensis, Bacillus xiamenensis, Bacillus xiapuensis, Bacillus zhangzhouensis, or combinations thereof.

In some examples, the bacterial strains that form spores may be strains of Bacillus, including: Bacillus sp. strain SD-6991; Bacillus sp. strain SD-6992; Bacillus sp. strain NRRL B-50606; Bacillus sp. strain NRRL B-50887; Bacillus pumilus strain NRRL B-50016; Bacillus amyloliquefaciens strain NRRL B-50017; Bacillus amyloliquefaciens strain PTA-7792 (previously classified as Bacillus atrophaeus); Bacillus amyloliquefaciens strain PTA-7543 (previously classified as Bacillus atrophaeus); Bacillus amyloliquefaciens strain NRRL B-50018; Bacillus amyloliquefaciens strain PTA-7541; Bacillus amyloliquefaciens strain PTA-7544; Bacillus amyloliquefaciens strain PTA-7545; Bacillus amyloliquefaciens strain PTA-7546; Bacillus subtilis strain PTA-7547; Bacillus amyloliquefaciens strain PTA-7549; Bacillus amyloliquefaciens strain PTA-7793; Bacillus amyloliquefaciens strain PTA-7790; Bacillus amyloliquefaciens strain PTA-7791; Bacillus subtilis strain NRRL B-50136 (also known as DA-33R, ATCC accession No. 55406); Bacillus amyloliquefaciens strain NRRL B-50141; Bacillus amyloliquefaciens strain NRRL B-50399; Bacillus licheniformis strain NRRL B-50014; Bacillus licheniformis strain NRRL B-50015; Bacillus amyloliquefaciens strain NRRL B-50607; Bacillus subtilis strain NRRL B-50147 (also known as 300R); Bacillus amyloliquefaciens strain NRRL B-50150; Bacillus amyloliquefaciens strain NRRL B-50154; Bacillus megaterium PTA-3142; Bacillus amyloliquefaciens strain ATCC accession No. 55405 (also known as 300); Bacillus amyloliquefaciens strain ATCC accession No. 55407 (also known as PMX); Bacillus pumilus NRRL B-50398 (also known as ATCC 700385, PMX-1, and NRRL B-50255); Bacillus cereus ATCC accession No. 700386; Bacillus thuringiensis ATCC accession No. 700387 (all of the above strains are available from Novozymes, Inc., USA); Bacillus amyloliquefaciens FZB24 (e.g., isolates NRRL B-50304 and NRRL B-50349 TAEGRO® from Novozymes), Bacillus subtilis (e.g., isolate NRRL B-21661 in RHAPSODY®, SERENADE® MAX and SERENADE® ASO from Bayer CropScience), Bacillus pumilus (e.g., isolate NRRL B-50349 from Bayer CropScience), Bacillus amyloliquefaciens TrigoCor (also known as “TrigoCor 1448”; e.g., isolate Embrapa Trigo Accession No. 144/88.4Lev, Cornell Accession No. Pma007BR-97, and ATCC accession No. 202152, from Cornell University, USA) and combinations thereof.

In some examples, the bacterial strains that form spores may be strains of Bacillus amyloliquefaciens. For example, the strains may be Bacillus amyloliquefaciens strain PTA-7543 (previously classified as Bacillus atrophaeus), and/or Bacillus amyloliquefaciens strain NRRL B-50154, Bacillus amyloliquefaciens strain PTA-7543 (previously classified as Bacillus atrophaeus), Bacillus amyloliquefaciens strain NRRL B-50154, or from other Bacillus amyloliquefaciens organisms.

In some examples, the bacterial strains that form spores may be Brevibacillus spp., e.g., Brevibacillus brevis; Brevibacillus formosus; Brevibacillus laterosporus; or Brevibacillus parabrevis, or combinations thereof.

In some examples, the bacterial strains that form spores may be Paenibacillus spp., e.g., Paenibacillus alvei; Paenibacillus amylolyticus; Paenibacillus azotofixans; Paenibacillus cookii; Paenibacillus macerans; Paenibacillus polymyxa; Paenibacillus validus, or combinations thereof. The bacterial spores may have an average particle diameter of about 0.5 to 50 or from 2 to 50 microns or from 10 to 45 microns or from 0.5-6 microns, suitably about 1-5 microns. Bacillus spores are commercially available in blends in aqueous carriers and are insoluble in the aqueous carriers. Other commercially available bacillus spore blends include without limitation Freshen Free™ CAN (10×), available from Novozymes Biologicals, Inc.; Evogen® Renew Plus (10×), available from Genesis Biosciences, Inc.; and Evogen® GT (10×, 20× and 110×), all available from Genesis Biosciences, Inc. In the foregoing list, the parenthetical notations (10×, 20×, and 110×) indicate relative concentrations of the Bacillus spores.

Bacterial spores used in the compositions, methods, and products disclosed herein may or may not be heat activated. In some examples, the bacterial spores are heat activated. In some examples, the bacterial spores are not heat inactivated. Preferably, the spores used herein are heat activated. Heat activation may comprise heating bacterial spores from room temperature (15-25° C.) to optimal temperature of between 25-120° C., preferably between 40 C-100° C., and held the optimal temperature for not more than 2 hours, preferably between 70-80° C. for 30 min.

For the methods, compositions and products disclosed herein, populations of bacterial spores are generally used. In some examples, a population of bacterial spores may include bacterial spores from a single strain of bacterium. Preferably, a population of bacterial spores may include bacterial spores from 2, 3, 4, 5, or more strains of bacteria. Generally, a population of bacterial spores contains a majority of spores and a minority of vegetative cells. In some examples, a population of bacterial spores does not contain vegetative cells. In some examples, a population of bacterial spores may contain less than about 1%, 2%, 3%, 4%, 5%, 6%, 7%, 8%, 9%, 10%, 15%, 20%, 25%, 30%, 40%, or 50% vegetative cells, where the percentage of bacterial spores is calculated as ((vegetative cells/(spores in population+vegetative cells in population))×100). Generally, populations of bacterial spores used in the disclosed methods, compositions and products are stable (i.e. not undergoing germination), with at least some individual spores in the population capable of germinating.

Populations of bacterial spores used in this disclosure may contain bacterial spores at different concentrations. In various examples, populations of bacterial spores may contain, without limitation, at least 1×10², 5×10², 1×10³, 5×10³, 1×10⁴, 5×10⁴, 1×10⁵, 5×10⁵, 1×10⁶, 5×10⁶, 1×10⁷, 5×10⁷, 1×10⁸, 5×10⁸, 1×10⁹, 5×10⁹, 1×10¹⁰, 5×10¹⁰, 1×10¹¹, 5×10¹¹, 1×10¹², 5×10¹², 1×10¹³, 5×10¹³, 1×10¹⁴, or 5×10¹⁴ spores/ml, spores/gram, or spores/cm³.

A preferred composition to provide the bacterial spore to the rinse can be an aqueous composition having a pH of from about 1 to about 6 as measured at 20° C., preferably the composition comprises from 1 to 20% by weight of the composition of an organic acid, preferably the organic acid is selected from the group consisting of acetic acid, citric acid, lactic acid and mixtures thereof. Preferably, the composition comprises a polymer. Preferably, the composition comprises a soil release polymer.

Preferably the composition comprises:
(a) an organic acid, preferably selected from the group consisting of acetic acid, citric acid, lactic acid and mixtures thereof;
(b) from about 1% to about 25%, by weight of the composition, of a first polymer, the first polymer being a soil release polymer (SRP); and
(c) optionally from about 1% to about 25%, by weight of the composition, of a second polymer, preferably, the second polymer being a graft copolymer, an alkoxylated polyalkyleneimine polymer, or a mixture thereof, wherein the graft copolymer, if present, comprises
   i) water-soluble polyalkylene oxides as a graft base, and
   ii) one or more side chains formed by polymerization of a vinyl ester component.

The composition may comprise first polymer (a) which is a soil release polymer (such as a terphthalate-derived soil release polymer), and second polymer (b) selected from a PEG/vinyl acetate graft copolymer, an alkoxylated polyalkylencimine polymer, or mixtures thereof. Polymers (a) and (b) may form a polymer system. The polymer system may include additional polymers, preferably polymers that provide a benefit to fabrics. As shown by the examples below, fabric treatment compositions that include polymers (a) and (b) in combination provide superior wicking benefits to fabrics when compared to compositions that comprise only polymer (a) or polymer (b).

Cleaning compositions suitable to provide the surfactant system to the wash liquor can further include an enzyme, an enzyme stabilizing system, a detergent builder, a chelating agent, a complexing agent, clay soil removal/anti-redeposition agents, polymeric soil release agents, polymeric dispersing agents, polymeric grease cleaning agents, a dye transfer inhibiting agent, a foam booster, an anti-foam, a suds suppressor, an anti-corrosion agent, a soil-suspending agent, a dye, a hueing dye, a tarnish inhibitor, an optical brightener, a perfume, a saturated or unsaturated fatty acid, a calcium cation, a magnesium cation, a visual signaling ingredient, a structurant, a thickener, an anti-caking agent, a starch, sand, a gelling agents, or any combination thereof.

Surfactant System: The surfactant system may comprise a detersive surfactant selected from anionic surfactants, nonionic surfactants, cationic surfactants, zwitterionic surfactants, amphoteric surfactants, ampholytic surfactants, and mixtures thereof. Those of ordinary skill in the art will understand that a detersive surfactant encompasses any surfactant or mixture of surfactants that provide cleaning, stain removing, or laundering benefit to soiled material. Preferably the composition is substantially free of cationic surfactant. Preferably, the composition comprises anionic and non-ionic surfactants.

The laundry detergent composition may comprise from 1 to 60 wt % an anionic surfactant. Preferred anionic surfactants are sulfonate and sulfate surfactants, preferably alkylbenzene sulphonates and/or (optionally alkoxylated) alkyl sulfates. Particularly preferred anionic surfactant comprises linear alkylbenzene sulfonates (LAS). Preferred alkyl sulfates comprise alkyl ether sulfates, especially C-9-15 alcohol ether sulfates, especially those having an average degree of ethoxylation from 0.5 to 7, preferably from 1 to 5, C8-C16 ester sulfates and C10-C14 ester sulfates, such as mono dodecyl ester sulfates. In a preferred composition the anionic surfactant comprises alkyl benzene sulphonate and optionally in addition, optionally ethoxylated alkyl sulfate, preferably having a degree of ethoxylation from 0 to 7, more preferably from 0.5 to 3. Isomers of LAS, branched alkylbenzenesulfonates (BABS), phenylalkanesulfonates, alpha-olefinsulfonates (AOS), olefin sulfonates, alkene sulfonates, alkane-2,3-diylbis(sulfates), hydroxyalkanesulfonates and disulfonates, alkyl sulfates (AS) such as sodium dodecyl sulfate (SDS), fatty alcohol sulfates (FAS), primary alcohol sulfates (PAS), alcohol ether sulfates (AES or AEOS or FES, also known as alcohol ethoxy sulfates or fatty alcohol ether sulfates), secondary alkanesulfonates (SAS), paraffin sulfonates (PS), ester sulfonates, sulfonated fatty acid glycerol esters, alpha-sulfo fatty acid methyl esters (alpha-SFMe or SES) including methyl ester sulfonate (MES), alkyl- or alkenylsuccinic acid, dodecenyl/tetradecenyl succinic acid (DTSA), fatty acid derivatives of amino acids, diesters and monoesters of sulfo-succinic acid or salt of fatty acids (soap), and combinations thereof are also suitable anionic surfactants.

The anionic surfactant is preferably added to the detergent composition in the form of a salt. Preferred cations are alkali metal ions, such as sodium and potassium. However, the salt form of the anionic surfactant may be formed in situ by neutralization of the acid form of the surfactant with alkali such as sodium hydroxide or an amine, such as mono-, di-, or tri-ethanolamine. The composition preferably comprises from 1 to 60 weight % or from 1 to 50 wt % or 2 or 5 to 40 wt % of the composition, anionic surfactant. The surfactant preferably comprises a surfactant system comprising an anionic surfactant and in addition, one or more additional surfactants, which may be non-ionic including semi-polar and/or cationic and/or zwitterionic and/or ampholytic and/or amphoteric and/or semi-polar nonionic and/or mixtures thereof.

Suitable nonionic surfactants include alcohol ethoxylates (AE), alcohol propoxylates, propoxylated fatty alcohols (PFA), alkoxylated fatty acid alkyl esters, such as ethoxylated and/or propoxylated fatty acid alkyl esters, alkylphenol ethoxylates (APE), nonylphenol ethoxylates (NPE), alkylpolyglycosides (APG), alkoxylated amines, fatty acid monoethanolamides (FAM), fatty acid diethanolamides (FADA), ethoxylated fatty acid monoethanolamides (EFAM), propoxylated fatty acid monoethanolamides (PFAM), polyhydroxyalkyl fatty acid amides, or N-acyl N-alkyl derivatives of glucosamine (glucamides, GA, or fatty acid glucamides, FAGA), as well as products available under the trade names SPAN and TWEEN, and combinations thereof. Alcohol ethoxylates are particularly preferred, preferably having a C9-18 or preferably a C12-15 alkyl chain and preferably having an average degree of ethoxylation from 3 to 9, more preferably from 3 to 7. Commercially available nonionic surfactants cleaning include Plurafac™, Lutensol™ and Pluronic™ from BASF, Dehypon™ series from Cognis and Genapol™ series from Clariant.

The detergent composition preferably comprises from 0.5 wt % to about 40 wt % of a non-ionic surfactant, preferably 1 to 30 wt % of the composition non-ionic surfactant.

Enzymes. Preferably the composition comprises one or more enzymes. Preferred enzymes provide cleaning performance and/or fabric care benefits. Examples of suitable enzymes include, but are not limited to, hemicellulases, peroxidases, proteases, cellulases, xylanases, lipases, phospholipases, esterases, cutinases, pectinases, mannanases, galactanases, pectate lyases, keratinases, reductases, oxidases, phenoloxidases, lipoxygenases, ligninases, pullulanases, tannases, pentosanases, malanases, β-glucanases, arabinosidases, hyaluronidase, chondroitinase, laccase, and amylases, or mixtures thereof. A typical combination is an enzyme cocktail that may comprise, for example, a protease and lipase in conjunction with amylase.

Enzyme Stabilizing System. The composition may optionally comprise from about 0.001% to about 10% by weight of the composition, of an enzyme stabilizing system. The enzyme stabilizing system can be any stabilizing system which is compatible with the detersive enzyme. In the case of aqueous detergent compositions comprising protease, a reversible protease inhibitor, such as a boron compound, including borate, 4-formyl phenylboronic acid, phenylboronic acid and derivatives thereof, or compounds such as calcium formate, sodium formate and 1,2-propane diol may be added to further improve stability.

Builder. The composition may optionally comprise a builder or a builder system. Built cleaning compositions typically comprise at least about 1% builder, based on the total weight of the composition. Liquid cleaning compositions may comprise up to about 10% builder, and in some examples up to about 8% builder, of the total weight of the composition. Granular cleaning compositions may comprise up to about 30% builder, and in some examples up to about 5% builder, by weight of the composition.

Builders selected from aluminosilicates (e.g., zeolite builders, such as zeolite A, zeolite P, and zeolite MAP) and silicates assist in controlling mineral hardness in wash water, especially calcium and/or magnesium, or to assist in the removal of particulate soils from surfaces. Suitable builders may be selected from the group consisting of phosphates, such as polyphosphates (e.g., sodium tri-polyphosphate), especially sodium salts thereof; carbonates, bicarbonates, sesquicarbonates, and carbonate minerals other than sodium carbonate or sesquicarbonate; organic mono-, di-, tri-, and tetracarboxylates, especially water-soluble nonsurfactant carboxylates in acid, sodium, potassium or alkanolammonium salt form, as well as oligomeric or water-soluble low molecular weight polymer carboxylates including aliphatic and aromatic types; and phytic acid. These may be complemented by borates, e.g., for pH-buffering purposes, or by sulfates, especially sodium sulfate and any other fillers or carriers which may be important to the engineering of stable surfactant and/or builder-containing cleaning compositions. Additional suitable builders may be selected from citric acid, lactic acid, fatty acid, polycarboxylate builders, for example, copolymers of acrylic acid, copolymers of acrylic acid and maleic acid, and copolymers of acrylic acid and/or maleic acid, and other suitable ethylenic monomers with various types of additional functionalities. Also suitable for use as builders herein are synthesized crystalline ion exchange materials or hydrates thereof having chain structure and a composition represented by the following general anhydride form: x(M₂O)·ySiO₂·zM′O wherein M is Na and/or K, M′ is Ca and/or Mg; y/x is 0.5 to 2.0; and z/x is 0.005 to 1.0.

Alternatively, the composition may be substantially free of builder.

Chelating Agent. The composition may also comprise one or more metal ion chelating agents. Suitable molecules include copper, iron and/or manganese chelating agents and mixtures thereof. Such chelating agents can be selected from the group consisting of phosphonates, amino carboxylates, amino phosphonates, succinates, polyfunctionally-substituted aromatic chelating agents, 2-pyridinol-N-oxide compounds, hydroxamic acids, carboxymethyl inulins, and mixtures therein. Chelating agents can be present in the acid or salt form including alkali metal, ammonium, and substituted ammonium salts thereof, and mixtures thereof.

Dye Transfer Inhibiting Agent. The composition can further comprise one or more dye transfer inhibiting agents. Suitable dye transfer inhibiting agents include, for example, polyvinylpyrrolidone polymers, polyamine N-oxide polymers, copolymers of N-vinylpyrrolidone and N-vinylimidazole, polyvinyloxazolidones, polyvinylimidazoles, manganese phthalocyanine, peroxidases, polyvinylpyrrolidone polymers, ethylene-diamine-tetraacetic acid (EDTA); diethylene triamine penta methylene phosphonic acid (DTPMP); hydroxy-ethane diphosphonic acid (HEDP); ethylenediamine N,N′-disuccinic acid (EDDS); methyl glycine diacetic acid (MGDA); diethylene triamine penta acetic acid (DTPA); propylene diamine tetraacetic acid (PDT A); 2-hydroxypyridine-N-oxide (HPNO); or methyl glycine diacetic acid (MGDA); glutamic acid N,N-diacetic acid (N,N-dicarboxymethyl glutamic acid tetrasodium salt (GLDA); nitrilotriacetic acid (NTA); 4,5-dihydroxy-m-benzenedisulfonic acid; citric acid and any salts thereof; N-hydroxyethylethylenediaminetri-acetic acid (HEDTA), triethylenetetraaminehexaacetic acid (TTHA), N-hydroxyethyliminodiacetic acid (HEIDA), dihydroxyethylglycine (DHEG), ethylenediaminetetrapropionic acid (EDTP) and derivatives thereof or a combination thereof.

Preferably the composition is substantially free of bleaching compounds.

Brightener. Optical brighteners or other brightening or whitening agents may be incorporated at levels of from about 0.01% to about 1.2%, by weight of the composition.

Commercial brighteners, which may be used herein, can be classified into subgroups, which include, but are not necessarily limited to, derivatives of stilbene, pyrazoline, coumarin, benzoxazoles, carboxylic acid, methinecyanines, dibenzothiophene-5,5-dioxide, azoles, 5- and 6-membered-ring heterocycles, and other miscellaneous agents.

In some examples, the fluorescent brightener is selected from the group consisting of 4,4′-bis {[4-anilino-6-morpholino-s-triazin-2-yl]-amino}-2,2′-stilbenedisulfonate disodium (brightener 15, commercially available under the tradename Tinopal AMS-GX by Ciba Geigy Corporation), disodium4,4′-bis {[4-anilino-6-(N-2-bis-hydroxyethyl)-s-triazine-2-yl]-amino}-2,2′-stilbenedisulonate (commercially available under the tradename Tinopal UNPA-GX by Ciba-Geigy Corporation), disodium 4,4′-bis {[4-anilino-6-(N-2-hydroxyethyl-N-methylamino)-s-triazine-2-yl]-amino}-2,2′-stilbenedisulfonate (commercially available under the tradename Tinopal 5BM-GX by Ciba-Geigy Corporation). More preferably, the fluorescent brightener is disodium 4,4′-bis {[4-anilino-6-morpholino-s-triazin-2-yl]-amino}-2,2′-stilbenedisulfonate.

The brighteners may be added in particulate form or as a premix with a suitable solvent, for example nonionic surfactant, monoethanolamine, propane diol.

Fabric Hueing Agent. The composition may comprise a fabric hueing agent (sometimes referred to as shading, bluing or whitening agents). Typically, the hueing agent provides a blue or violet shade to fabric. Hueing agents can be used either alone or in combination to create a specific shade of hueing and/or to shade different fabric types. This may be provided for example by mixing a red and green-blue dye to yield a blue or violet shade. Hueing agents may be selected from any known chemical class of dye, including but not limited to acridine, anthraquinone (including polycyclic quinones), azine, azo (e.g., monoazo, disazo, trisazo, tetrakisazo, polyazo), including premetallized azo, benzodifurane and benzodifuranone, carotenoid, coumarin, cyanine, diazahemicyanine, diphenylmethane, formazan, hemicyanine, indigoids, methane, naphthalimides, naphthoquinone, nitro and nitroso, oxazine, phthalocyanine, pyrazoles, stilbene, styryl, triarylmethane, triphenylmethane, xanthenes and mixtures thereof.

Encapsulate. The composition may comprise an encapsulate. The encapsulate may comprises a core, a shell having an inner and outer surface, where the shell encapsulates the core.

In certain aspects, the encapsulate comprises a core and a shell, where the core comprises a material selected from perfumes; brighteners; dyes; insect repellants; silicones; waxes; flavors; vitamins; fabric softening agents; skin care agents, e.g., paraffins; enzymes; anti-bacterial agents; bleaches; sensates; or mixtures thereof; and where the shell comprises a material selected from polyethylenes; polyamides; polyvinylalcohols, optionally containing other co-monomers; polystyrenes; polyisoprenes; polycarbonates; polyesters; polyacrylates; polyolefins; polysaccharides, e.g., alginate and/or chitosan; gelatin; shellac; epoxy resins; vinyl polymers; water insoluble inorganics; silicone; aminoplasts, or mixtures thereof. In some aspects, where the shell comprises an aminoplast, the aminoplast comprises polyurea, polyurethane, and/or polyureaurethane. The polyurea may comprise polyoxymethyleneurea and/or melamine formaldehyde.

Other ingredients. The composition can further comprise silicates. Suitable silicates can include, for example, sodium silicates, sodium disilicate, sodium metasilicate, crystalline phyllosilicates or a combination thereof. In some embodiments, silicates can be present at a level of from about 1% to about 20% by weight, based on the total weight of the composition.

The composition can further comprise other conventional detergent ingredients such as foam boosters, suds suppressors, anti-corrosion agents, soil-suspending agents, anti-soil redeposition agents, dyes, bactericides, tarnish inhibiters, optical brighteners, or perfumes.

The composition can optionally further include saturated or unsaturated fatty acids, preferably saturated or unsaturated C12-C24 fatty acids; deposition aids, for example, polysaccharides, cellulosic polymers, poly diallyl dimethyl ammonium halides (DADMAC), and co-polymers of DADMAC with vinyl pyrrolidone, acrylamides, imidazoles, imidazolinium halides, and mixtures thereof, in random or block configuration, cationic guar gum, cationic cellulose, cationic starch, cationic polyacylamides or a combination thereof. If present, the fatty acids and/or the deposition aids can each be present at 0.1% to 10% by weight, based on the total weight of the composition.

The composition may optionally include silicone or fatty-acid based suds suppressors; hueing dyes, calcium and magnesium cations, visual signaling ingredients, anti-foam (0.001% to about 4.0% by weight, based on the total weight of the composition), and/or a structurant/thickener (0.01% to 5% by weight, based on the total weight of the composition) selected from the group consisting of diglycerides and triglycerides, ethylene glycol distearate, microcrystalline cellulose, microfiber cellulose, biopolymers, xanthan gum, gellan gum, and mixtures thereof).

### Examples

The following testing measures the impact of detergent surfactant concentration on deposition of Bacillus spores onto fabric, including treatments involving addition of the Bacillus spores as part of the detergent composition or part of a separate liquid fabric enhancer (LFE) composition added to a subsequent rinse cycle.

### Washing Protocol and Spore Deposition Analysis Method:

Knitted cotton swatches (GMT desized knitted cotton, Warwick Equest Ltd, Consett, UK) and SBL2004 swatches (SBL2004, wfk-Testgewebe GmbH, Brüggen-Bracht, Germany) were washed with a surfactant-free liquid laundry detergent formulation comprising 0.66% brightener, 0.77% chelating agent, 4.55% solvent/rheology modifier, 2.77% polymer, balance water, with separate dosing of the surfactant system comprised of 30% non-ionic AE7 (C12-14 alcohol ethoxylate with average 7 moles of ethoxylation), 40% LAS (linear alkylbenzenesulfonate), 30% AE3S (C12-14 alcohol ether sulfate with average three moles of ethoxylation) (Procter & Gamble), then rinsed with LFE (Lenor, Procter & Gamble) in an experiment involving four external and two internal replicates for each treatment.

| Test leg | Wash addition | Rinse addition |
|---|---|---|
| A | 0.79 g/L Nil surfactant Ariel Liquid + | Lenor LFE |
| | 0.35 g/L surfactant delivery + Bacillus | |
| | spores | |
| B | 0.79 g/L Nil surfactant Ariel Liquid + | Lenor LFE |
| | 3.5 g/L surfactant delivery + Bacillus | |
| | spores | |
| C | 0.79 g/L Nil surfactant Ariel Liquid + | Lenor LFE + |
| | 0.35 g/L surfactant delivery | Bacillus spores |
| D | 0.79 g/L Nil surfactant Ariel Liquid + | Lenor LFE + |
| | 3.5 g/L surfactant delivery | Bacillus spores |

The wash and rinse cycles were completed in a 1 L tergotometer containing city water (9 gpg hardness (US)), 5×SBL2004 5 cm×5 cm swatches, and 5 cm×5 cm knitted cotton swatches to make the total fabric mass 60 g. The fabrics were washed for 17 minutes at 26° C., 208 rpm, and then rinsed twice for 5 minutes in fresh water (15° C.). Bacillus spore premix (Genesis Biosciences, Cardiff, UK) was dosed to give a total count of 5×10⁶ colony forming units (CFU)/L in the wash (test legs 1+2) or second rinse (test legs 3+4). A stock 1 L wash solution was made up adding the desired number of spores, and samples of this stock solution were taken for Initial CFU/g fabric readings. Knitted cotton swatches were removed after the rinse cycle in all cases and were analysed for spore deposition via vortex extraction with 0.45 ml of 0.1% Tween 80 (P8074 Sigma-Aldrich) in 9 ml of 0.85% physiological saline (Trafalgar Scientific, Leicester, UK) to give a 10⁰ dilution. 10⁻¹ dilution was achieved through 1 ml serial dilution into 9 ml physiological saline. 200 μl aliquots of the 10⁰ and 10⁻¹ dilutions were plated in duplicate onto Tryptic Soy Agar (TSA) plates (Biomerieux UK Ltd, Basingstoke, UK) and spread with a sterile plastic wedge shaped spreader (Trafalgar Scientific, Leicester, UK). Plates were incubated at 35° C. for 18-24 hours and the resulting colonies were counted by eye. Counts from plates containing between 20 and 200 colonies were used to calculate the total colony forming units (CFU) per gram of fabric-see calculations below.

Similarly, the initial count samples were plated directly onto TSA plates for a 10⁰ dilution or were serially diluted with 1 ml into 9 ml of 0.85% physiological saline for a 10⁻¹ dilution then plated onto TSA plates. Counts from these plates were used to calculate the total CFU available per gram of fabric in the wash solution at the start as a theoretical 100% deposition to allow for a % deposition onto fabric calculation.

### Calculations:

### Fabric Extraction:

$$CFU / g fabric = CFU \times ( 1000 / 200 ) \times 9.45 ( to give total CFU in 9.45 ml extraction solution ) \times \\ 1 / 0.826 g ( swatch to gram conversion ) \times Dilution factor$$

### Initial:

$$Initial CFU / g fabric = ( CFU \times ( 1000 / 200 \times 1000 ) ) / 60 g \times Dilution factor$$

### Percentage Deposition:

$$\% deposition = ( ( Initial CFU / g ) / ( Fabric CFU / g ) ) \times 100$$

### Results:

Mean Initial CFU/g fabric: 53,750 CFU/g

| | | | Mean % | |
|---|---|---|---|---|
| | Mean | Standard | Spore | Standard |
| Treatment | log(CFU/g) | deviation | deposition | deviation |
| A-Low surfactant, | 3.40 | 0.419 | 4.65 | 3.261 |
| spores dosed TTW | | | | |
| B-High surfactant, | 3.04 | 0.165 | 2.03 | 0.828 |
| spores dosed TTW | | | | |
| C-Low surfactant, | 4.27 | 0.039 | 34.90 | 3.130 |
| spores dosed TTR | | | | |
| D-High surfactant, | 4.01 | 0.075 | 18.95 | 3.116 |
| spores dosed TTR | | | | |

### Statistical Analysis

Tukey's HSD was used to determine the statistical significance between the four treatments. While comparison of A versus B did not show a significant difference, all other pairwise comparisons were found to be statistically significantly different at 99% confidence level.

| Treatment | |
|---|---|
| comparison | p value |
| A-B | 0.675 |
| A-C | 0.0000017 |
| A-D | 0.000444 |
| B-C | 0.0000009 |
| B-D | 0.000121 |
| C-D | 0.000192 |

### CONCLUSION

Systems comprising delivery of Bacillus spores to the rinse achieve higher levels of deposition onto fabrics than formulation of the spores in the preceding washing cycle (comparison of treatment C versus A and D versus B). Surfactant level does not significantly impact spore deposition in the wash (comparison of treatment B versus A). However, the combination of spore delivery to the rinse AND a low surfactant level in the preceding wash (treatment C, invention) achieves a surprising and unexpected boost in spore deposition compared to all of the comparative treatments (A, B, D).

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A method of treating a fabric, the method comprising the step of:
i. subjecting the fabric to a wash liquor comprising from about 100 ppm to about 600 ppm of a surfactant system; and
ii. rising the fabric with a rinse liquor comprising from about 1×10² to about 1×10⁸ CFU/l of the aqueous liquor, of bacterial spores.

2. The method according to claim 1, wherein the surfactant system comprises an anionic and a nonionic surfactant.

3. The method according to claim 1, wherein the surfactant system comprises an anionic and a nonionic surfactant and wherein the anionic surfactant comprises a sulfonate and/or sulfate surfactant and the nonionic surfactant comprises and alcohol ethoxylated.

4. The method according to claim 1, wherein the surfactant system comprises an anionic and a nonionic surfactant and wherein the anionic surfactant comprises linear alkylbenzene sulfonate and alcohol ether sulfate.

5. The method according to the claim 1, wherein the surfactant system comprises an anionic and a nonionic surfactant and wherein the anionic to nonionic surfactant are in a weight ratio of from about 30:1 to about 1:2.

6. The method according to the claim 1, wherein the surfactant system comprises an anionic and a nonionic surfactant and wherein the anionic to nonionic surfactant are in a weight ratio of from about 20:1 to about 2:3.

7. The method according to claim 1, wherein the rinse liquor comprises from about 1×10³ to about 1×10⁷ CFU/l of the aqueous liquor, of bacterial spores.

8. The method according to claim 1, wherein the bacterial spores comprise Bacillus spores, p Bacillus selected from the group consisting of Bacillus subtilis, Bacillus amyloliquefaciens, Bacillus licheniformis, Bacillus megaterium, Bacillus pumilus, Bacillus cereus, Bacillus thuringiensis, Bacillus mycoides, Bacillus tequilensis, Bacillus vallismortis, Bacillus mojavensis and mixtures thereof, or selected from the group consisting of Bacillus subtilis, Bacillus amyloliquefaciens, Bacillus licheniformis, Bacillus megaterium, Bacillus pumilus and mixtures thereof.

9. The method according to claim 1, wherein the surfactant system is added to the wash liquor as part of a fully formulated detergent.

10. The method according to claim 1, wherein the surfactant system is added to the wash liquor as part of a fully formulated detergent and wherein the fully formulated detergent further comprises a cleaning adjunct.

11. The method according to claim 1, wherein fully formulated detergent is in liquid, solid or unit-dose from.

12. The method according to claim 1, wherein the method takes place in a washing machine comprising an auto-dosing system, wherein the auto-dosing system comprises a plurality of reservoirs, one reservoir comprising one or more surfactants and at least another reservoir comprising the bacterial spores.

13. The method according to claim 1, wherein the wash liquor is substantially free of bleach.

14. The method according to claim 1, wherein the rinse liquor is substantially free of fabric conditioning agent.
